(19) United States
(12) Patent Application Publication
(10) Pub. No.: US 2017/0027154 A1
(43) Pub. Date: Feb. 2, 2017

(54) HAND-HELD CLAMPING HERBICIDE APPLICATOR

(71) Applicant: James E. Waller, Monteagle, TN (US)

(72) Inventor: James E. Waller, Monteagle, TN (US)

(21) Appl. No.: 15/224,780

(22) Filed: Aug. 1, 2016

Related U.S. Application Data
(60) Provisional application No. 62/198,709, filed on Jul. 30, 2015.

(51) Int. Cl. A01M 21/04; B25G 1/04; B25G 1/10

(52) U.S. Cl. CPC A01M 21/043; B25G 1/102; B25G 1/04

(57) ABSTRACT

A hand-held herbicide delivery device for targeted application of herbicide to a targeted plant encompasses a shaft and at least two spring arms located proximate a first end of said shaft, said spring arms being capable of moving between an open position and a closed position. At least two sponges are affixed to said spring arms, such that when said spring arms are in a closed position said sponges are brought into close proximity with each other, said sponges being adapted to carry a herbicide. Herbicide is applied to the targeted plant by positioning the spring arms in the open position such that they surround the targeted plant and moving a hand-actuated trigger from an extended position to a retracted position so that flexible cables move said spring arms into the closed position, with said sponges directly contacting at least a portion of the targeted plant, whereby herbicide is transferred from said sponges to the targeted plant.

### CROSS-REFERENCES TO RELATED APPLICATIONS/PATENTS

This application relates back to and claims the benefit of priority from U.S. Provisional Application for Patent Ser. No. 62/198,709 titled “Hand-Held Clamping Herbicide Applicator” and filed on Jul. 30, 2015. The entire content of the foregoing application is incorporated herein by reference.

### FIELD OF THE INVENTION

The present invention relates generally to devices and assemblies for applying herbicide, and particularly to hand-held herbicide applicators.

### BACKGROUND AND DESCRIPTION OF THE PRIOR ART

It is known to use liquid applicators to apply liquids to targeted objects such undesirable plants, painted surfaces, and the like. Conventional liquid applicators, however, suffer from one or more disadvantages. For example, conventional liquid applicators do not limit the application of the liquid to only the targeted object. Conventional liquid applicators also do not uniformly , apply the liquid to the targeted object. Further, conventional liquid applicators do not permit the user to control the volume of liquid or the application force applied to the targeted object. Conventional liquid applicators are also not adapted to simultaneously apply liquid to more than a single side of the targeted object. In addition, conventional liquid applicators are not easily cleaned, maintained, and repaired. Still further, conventional liquid applicators result in undesirable dripping of the liquid.

It would be desirable, therefore, if an apparatus and method for a liquid applicator could be provided that would limit the application of the liquid to only the targeted object. It would also be desirable if such an apparatus and method for a liquid applicator could be provided that would uniformly apply the liquid to the targeted object. It would be further desirable if such an apparatus and method for a liquid applicator could be provided that would permit the user to control the volume of liquid or the application force applied to the targeted object. It would be still further desirable if such an apparatus and method for a liquid applicator could be provided that would simultaneously apply liquid to more than a single side of the targeted object. In addition, it would be desirable if an apparatus and method for a liquid applicator could be provided that would be easily cleaned, maintained, and repaired. Still further, it would be desirable if an apparatus and method for a liquid applicator could be provided that would not result in undesirable dripping of the liquid.

### ADVANTAGES OF THE PREFERRED EMBODIMENTS OF THE INVENTION

Accordingly, it is an advantage of the preferred embodiments of the invention claimed herein to provide an apparatus and method for a liquid applicator that limits the application of the liquid to only the targeted object. It is also an advantage of the preferred embodiments of the invention claimed herein to provide an apparatus and method for a liquid applicator that uniformly applies the liquid to the targeted object. It is another advantage of the preferred embodiments of the invention claimed herein to provide an apparatus and method for a liquid applicator that permits the user to control the volume of liquid and the application force applied to the targeted object. It is an advantage of the preferred embodiments of the invention claimed herein to provide an apparatus and method for a liquid applicator that simultaneously applies liquid to more than a single side of the targeted object. In addition, it is an advantage of the preferred embodiments of the invention claimed herein to provide an apparatus and method for a liquid applicator that is easily cleaned, maintained, and repaired. Still further, it is an advantage of the preferred embodiments of the invention claimed herein to provide an apparatus and method for a liquid applicator that does not result in undesirable dripping of the liquid.

Additional advantages of the preferred embodiments of the invention will become apparent from an examination of the drawings and the ensuing description.

### SUMMARY OF THE INVENTION

Disclosed herein are example embodiments of a hand-held device for applying herbicide at controlled rates of flow to the foliage of unwanted plants by means of clamping, movable poly-foam sponges upon the foliage of target plants. Sponges and sponge clamping components of the device, attached at the application end of a shaft and at a distance from the operator, are impregnated with liquid herbicide. Hand clamping of the device at the operator end of the shaft causes the sponges to be squeezed together onto the target plant, whereby liquid herbicide is extracted from the sponges at a controlled rate and applied directly to the clamped foliage of a target plant, including as the sponges are pulled over the foliage of the plant.

In preferred example embodiments of the present general inventive concept, a hand-held herbicide delivery device for targeted application of herbicide to a targeted plant encompasses a shaft having a length, a first end, and a second end; at least two spring arms located proximate said first end of said shaft, said spring arms being capable of moving between an open position and a closed position, at least two sponges affixed to said spring arms, such that when said spring al is are in a closed position said sponges are brought into close proximity with each other, said sponges being adapted to carry a herbicide; a hand-actuated trigger located proximate said second end of said shaft and being adapted to move between an extended position and a retracted position; flexible cables extending along a majority of the length of said shaft and adapted to move said spring arms between the open position and the closed position and adapted to move said sponges into close proximity with each other in response to movement of said hand-actuated trigger between the extended position and the retracted position; wherein herbicide is applied to the targeted plant by positioning the spring arms in the open position such that they surround the targeted plant and moving said hand-actuated trigger from the extended position to the retracted position so that the flexible cables move said spring arms into the closed position, with said sponges directly contacting at least a portion of the targeted plant, whereby herbicide is transferred from said sponges to the targeted plant.

In some example embodiments of the present general inventive concept, a liquid applicator adapted to apply a liquid to a targeted object includes a handle, said handle being adapted to be moved between an extended position and a retracted position; a first arm, said first arm having a first arm distal end and being adapted to be moved between a first arm open position and a first arm closed position; a first paddle, said first paddle being disposed on the first arm distal end; a second arm, said second arm having a second arm distal end and being adapted to be moved between a second arm open position and a second arm closed position; a second paddle, said second paddle being disposed on the second arm distal end; means for moving said first arm from the first arm open position to the first arm closed position in response to movement of said handle from the extended position to the retracted position; and means for moving said second arm from the second arm open position to the second arm closed position in response to movement of said handle from the extended position to the retracted position; wherein the first paddle and the second paddle are adapted to releasably retain the liquid and apply the liquid to the targeted object; and wherein the first paddle and the second paddle are adapted to contact each other when the first arm is in the first aim closed position and the second arm is in the second arm closed position.

### BRIEF DESCRIPTION OF THE DRAWINGS

The presently preferred embodiments of the invention are illustrated in the accompanying drawings, in which like reference numerals represent like parts throughout, and in which:

FIG. 1 is a perspective view of the one example embodiment of a hand-held herbicide applicator in accordance with the present general inventive concept;

FIG. 2 is a close-up view of the head portion of the example embodiment hand-held herbicide applicator illustrated in FIG. 1, showing the clamp members and sponges in an open position;

FIG. 3 is a close-up view of the head portion of the example embodiment hand-held herbicide applicator illustrated in FIGS. 1 and 2, showing the clamp members and sponges in a partially closed position;

FIG. 4 is a close-up view of the head portion of the example embodiment hand-held herbicide applicator illustrated in FIGS. 1-3, showing the clamp members and sponges in a fully closed position;

FIG. 5a is a close-up view of the trigger and hand grip components of the example embodiment hand-held herbicide applicator illustrated in FIGS. 1-4, showing the trigger in an extended position;

FIG. 5b is another close-up view of the trigger and hand grip components of the example embodiment hand-held herbicide applicator illustrated in FIG. 5a, showing the trigger in a retracted position;

FIG. 6 is a partial sectional view of a portion of the example embodiment hand-held herbicide applicator illustrated in FIGS. 1-5b, showing linkages between tensioning cables within the tubular shaft and components of the trigger and hand grip;

FIG. 7 is a side partial view of the tubular shaft of one example embodiment according to the present general inventive concept, showing a tubular elbow and a stabilizing handle;

FIG. 8a is a top view of a snap-in connector to be used in attaching, removing and/or replacing sponges on the spring arms of a hand-held herbicide applicator as described herein;

FIG. 8b is a side view of the snap-in connector illustrated in FIG. 8a;

FIG. 8c is an end view of a female component of the snap-in connector illustrated in FIGS. 8a and 8b; and

FIG. 8d is an end view of a male component of the snap-in connector illustrated in FIGS. 8a and 8b.

### DETAILED DESCRIPTION OF EMBODIMENTS OF THE INVENTION

The present general inventive concept, in various example embodiments, including those disclosed and illustrated herein, encompasses a hand-held device for the targeted application of herbicide at controlled rates to unwanted plants. This hand-held device, in various example embodiments, includes a tubular body with at least two sponges at one end; a controller mechanism for directing the movement of these sponges is located at the other end of the tubular body, allowing an operator to control the sponges and apply the herbicide at a distance from the sponges and herbicide. In addition to safely removing the operator from proximity to the herbicide, this tubular body configuration frequently enables the use of the device on ground-located plants by an operator who remains in a standing position. The sponges act as carriers for the herbicide. The device includes apparatus for bringing the sponges together that is, for moving the sponges from an open position, where some distance separates the sponges from each other, to a closed or “clamped” position, where at least one face or surface of each sponge is substantially in contact with or in close proximity to at least one face or surface of each other sponge. This clamping operation generally is part of the procedure for delivering herbicide from the sponges to an unwanted plant: the sponges are clamped around the stalk or some other portion of the plant, at which point herbicide carried by the sponges is transferred to the plant. Hand clamping of the device at the operator end of the tubular body causes the sponges to be squeezed together onto the target plant, whereby herbicide is extracted from the sponges at a controlled rate and applied directly to the target plant.

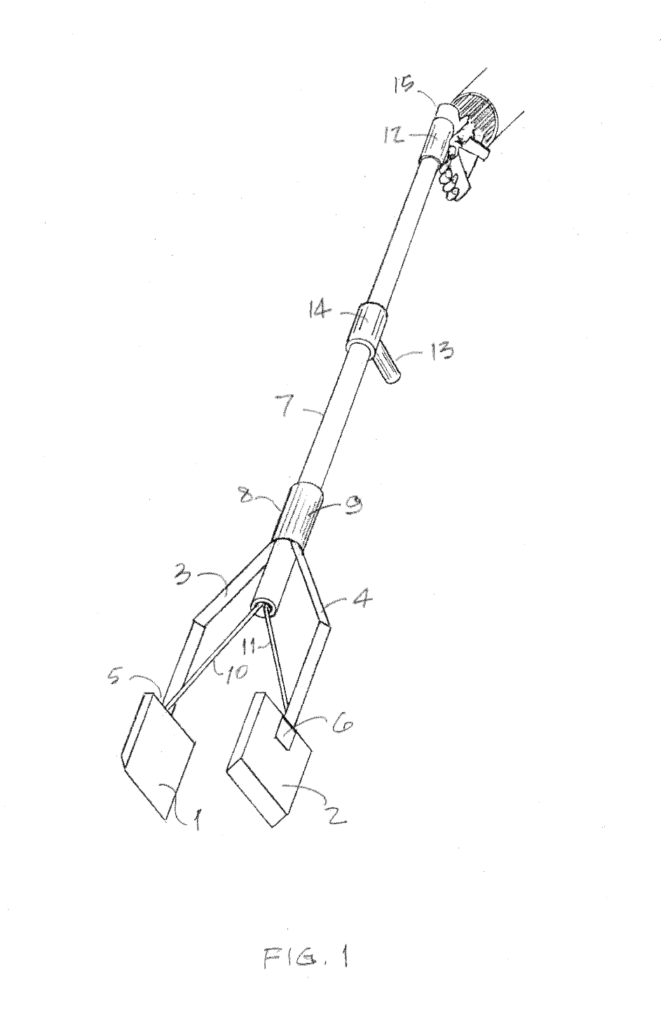

Referring now to the drawings, FIG. 1 is a perspective view of one example the invention, held as one would employ the device for applying herbicide to a plant or clamping sponges upon an object for the purposes of the invention described herein.

FIG. 1 shows a hand-held herbicide delivery device for targeted application of herbicide to a targeted plant. The example embodiment device illustrated in FIG. 1 includes sponges 1 and 2 are each respectively attached to flexible spring arms 3 and 4; in a preferred embodiment, the sponges 1 and 2 are each respectively attached to flexible spring arms 3 and 4 by connectors 5 and 6, preferably snap-in connectors. The sponges 1 and 2 are adapted to carry a herbicide, preferably a liquid herbicide. In some preferred embodiments, the sponges 1 and 2 are poly-foam sponges.

The connectors 5 and 6 generally include slot connectors with deformations, adhered to or otherwise attached to the foam sponges, and deformed flat inserts on the ends of the flexible spring aims 3 and 4, which engage the deformations in the slot connectors. In several embodiments, the connectors 5 and 6 are fabricated from polyvinyl chloride (PVC) or similar material. Generally, attachment and detachment of the sponges 1 and 2 for replacement requires an applied tension force of not less than two and not more than five pounds.

The illustrated hand-held herbicide delivery device includes a shaft 7 having a length, a first end, and a second end. The two spring arms 3 and 4 are located proximate the first end of the shaft 7. The two spring arms 3 and 4 are preferably rigidly attached to the shaft 7 by preferably rigidly connected semi-tubular collars 8 and 9, which are bonded or otherwise attached to the shaft 7. In various embodiments, the flexible spring arms 3 and 4, the shaft 7, and connected devices are fabricated from PVC, metal, or other similar and suitable materials. In various embodiments, the shaft 7 is preferably a tubular shaft.

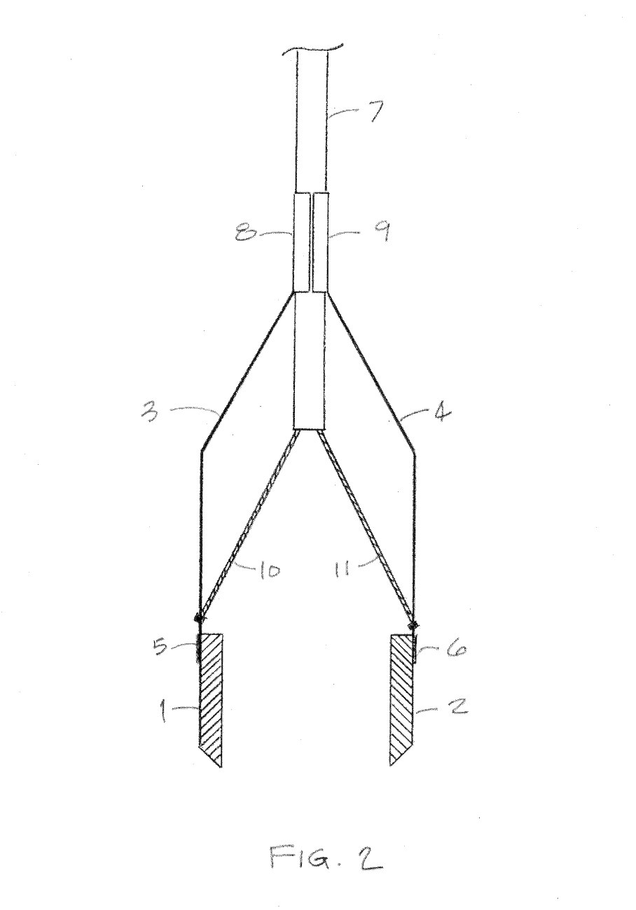

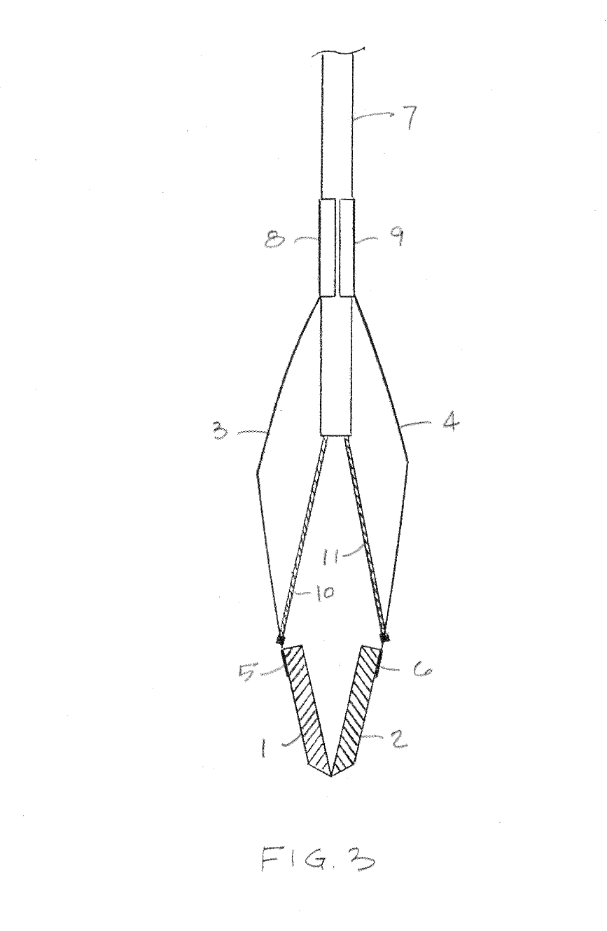

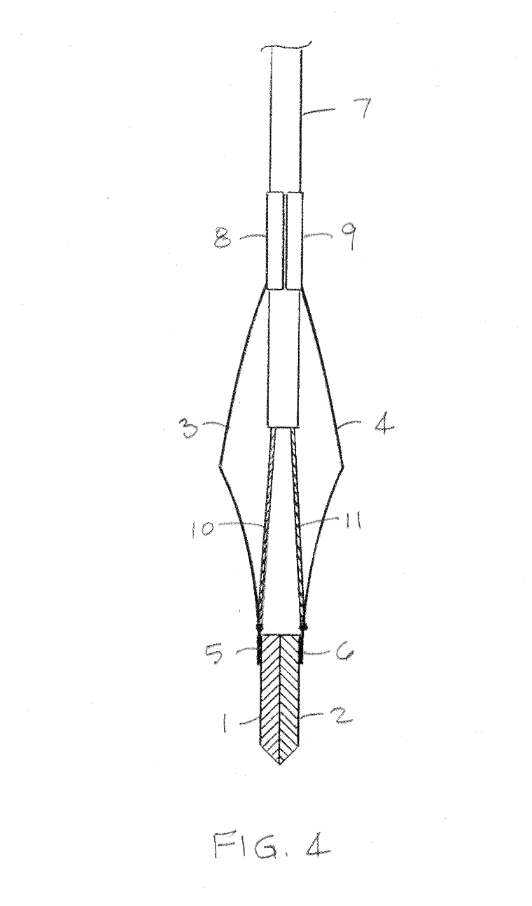

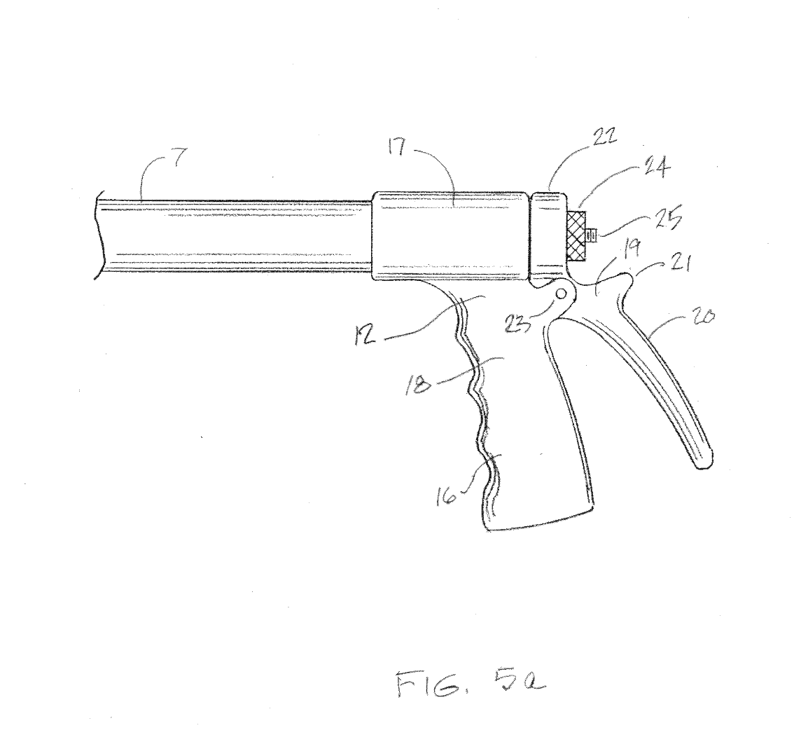

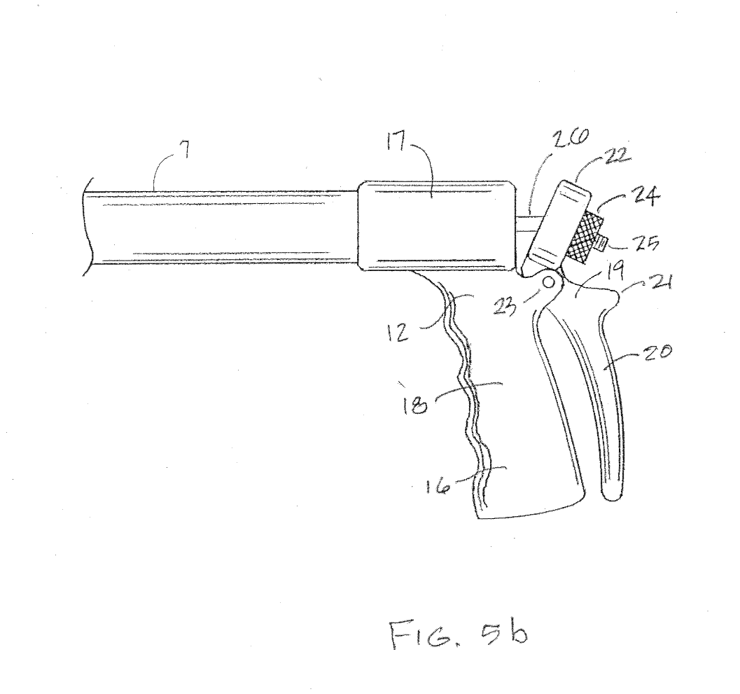

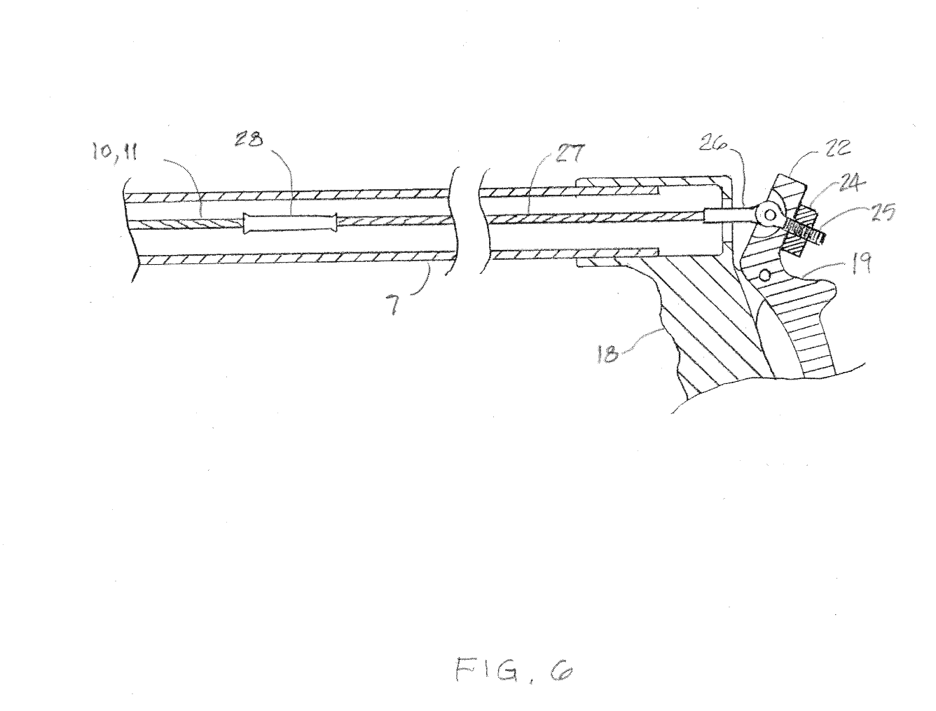

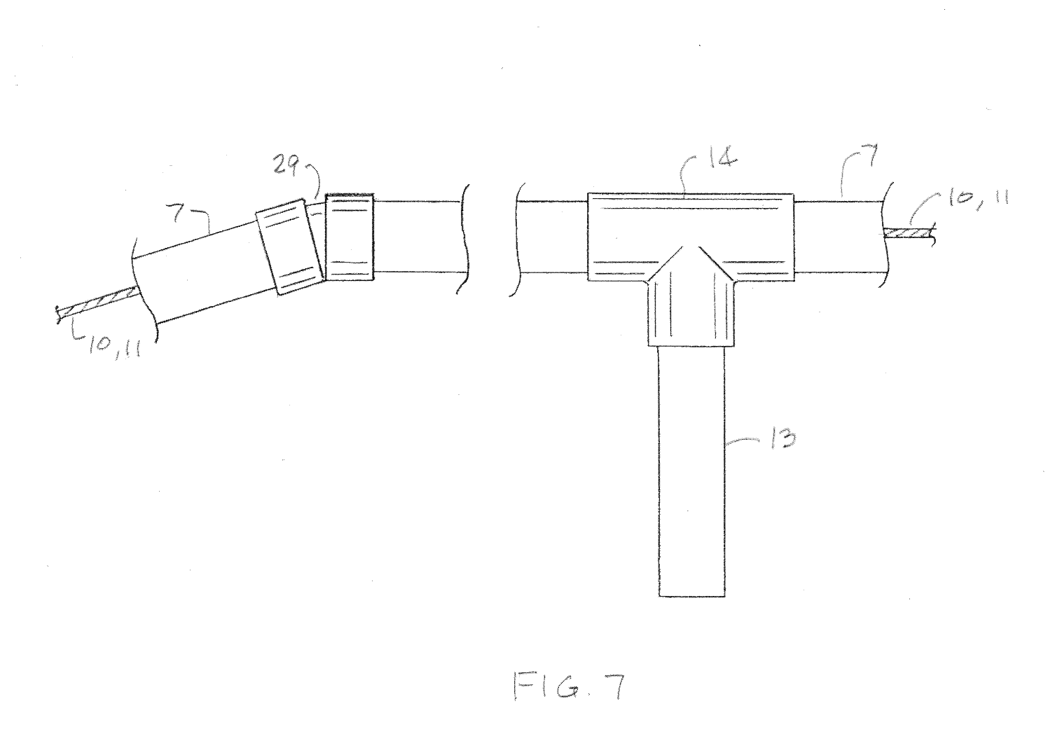

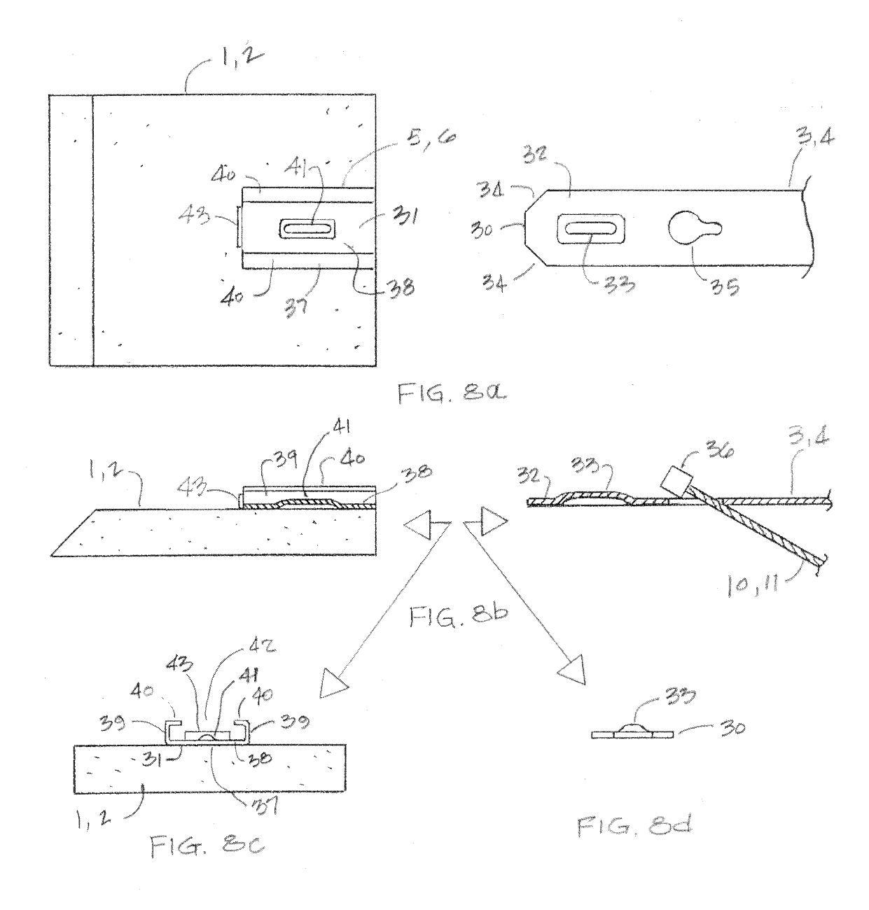

The spring arms 3 and 4 are capable of moving between an open position (shown, for example, in FIG. 1 and in a close-up view in FIG. 2) and a closed position (shown in FIG. 4). Flexible cables 10 and 11 extend along a majority of the length of the shaft 7 and are adapted to move the spring arms 3 and 4 between the open position and the closed position. In turn, movement of the spring arms 3 and 4 from the open position to the closed position brings the sponges 1 and 2 into close proximity with each other; that is, the flexible cables 10 and 11 are adapted to move the sponges 1 and 2 into close proximity with each other. The flexible cables 10 and 11 move the spring arms 3 and 4 between the open position and the closed position, and move the sponges 1 and 2 into close proximity with each other, in response to movement of a hand-actuated trigger 12 between an extended position and a retracted position. This hand-actuated trigger 12 is located proximate the second end of the shaft 7.

In the illustrated example embodiment, to move the spring arms 3 and 4 into the closed position, the hand-actuated trigger 12 is moved from an extended position to a retracted position, whereby tension is applied to the two flexible cables 10 and 11 and thence to the spring anus 3 and 4 at or near the connectors 5 and 6, to which the flexible cables 10 and 11 are attached by screws, cable-end stops, or similar fixtures. Flexible straps, fabricated from other suitable materials, in various embodiments may be substituted for the flexible cables 10 and 11 and connected by similar means. The two cables 10 and 11 flexibly extend entirely through the shaft 7 and connect to components of a hand-operated hand-actuated trigger 12 described below. Clamping force, applied to the hand-actuated trigger 12, causes added tensile force to be applied to cables 10 and 11. The added tension in cables 10 and 11 causes the free ends of the spring anus 3 and 4 to flex toward one another, resulting in the movable sponges 1 and 2 simultaneously moving toward one another as shown in FIGS. 3 and 4. A partially closed position of spring arms 3 and 4 is illustrated in FIG. 3, and a fully closed position of spring arms 3 and 4 is shown in FIG. 4; this fully closed position results from maximum hand compression being applied to the hand-actuated trigger 12, resulting in maximum tension being applied to the cables 10 and 11.

Herbicide is applied to a targeted plant by positioning the spring arms 3 and 4 in the open position such that they surround the targeted plant; next, the hand-actuated trigger 12 is moved from the extended position to the retracted position so that the flexible cables 10 and 11 move the spring arms 3 and 4 into the closed position, with the sponges 1 and 2 directly contacting at least a portion of the targeted plant, whereby herbicide is transferred from said sponges to the targeted plant.

When the hand clamping force on the hand-actuated trigger 12 is released, tension on the two cables 10 and 11 is reduced along with the force acting on the free ends of the spring arms 10 and 11. As the forces on cables 10 and 11 are reduced, the free ends of the spring arms 10 and 11 and the connected sponges 1 and 2 return to the open position shown in FIGS. 1 and 2. During manufacture of the device, cables 10 and 11 are initially attached to the ends of each spring arm 3 and 4 while the spring arm is flexed to meet the connector for the cable 10 and 11, in the fashion of attaching a bow string to an archery bow. Thus, the cables 10 and 11 are always in tension when the hand-actuated trigger 12 is in the extended position.

FIG. 1 also shows an optional, adjustable hand-stabilizing bar 13, which may be attached to the shaft 7 by means of a relocatable tubular collar clamping device 14.

Turning now to FIG. 2, the spring arms 3 and 4 are shown in the open position. In this position, the cables 10 and 11 are under tensile forces applied by the initially flexed spring arms 3 and 4. The spacing and orientation between the movable sponges 1 and 2 is initially determined by the location of attachment of the semi-tubular collars 8 and 9 connecting the spring arms 3 and 4 to the shaft 7 relative to the end of the shaft 7 where the cables 3 and 4 enter the shaft opening. Optimal spacing of the sponges 1 and 2 depends on such factors as, for instance, the opening size of a container containing herbicide into which the sponges 1 and 2 are to be dipped. Optional and relocatable clamping connections of the semi-tubular collars 8 and 9 connecting the spring arms 3 and 4 to the shaft 7 permit alternate spacing and orientation of the sponges 1 and 2. After fabrication of the herbicide application device, the location of the movable sponges 1 and 2 are dependent upon the hand-clamping force applied to the hand-actuated trigger 12 of the device. A thumb nut 15 may also be used to make adjustments to the fully open position of the spring aims 10 and 11 and the attached sponges 1 and 2.

FIG. 3 shows the sponges 1 and 2 in contact at their extreme ends. Where the sponges 1 and 2 have been impregnated with herbicide, the flow of herbicide will proceed as the sponges 1 and 2 are pressed together beyond that shown when herbicide is squeezed out of the compressed foam sponges 1 and 2.

Turning now to FIG. 4, the sponges 1 and 2 are shown to be in full contact—that is, the spring arms 3 and 4 are fully in the closed position. Between the position shown in FIG. 3 and the position shown in FIG. 4, herbicide has been squeezed out of the foam sponges 1 and 2 onto the target foliage clamped between the inside faces of the sponges 1 and 2. Additional clamping force on the hand-actuated trigger 12 further increases the tension on the two cables 10 and 11 causing the sponges 1 and 2 to press together with greater pressure. This further compresses and squeezes the sponges 1 and 2, resulting in an increased amount of herbicide being deposited on the clamped foliage.

Turning now to FIG. 5a, the shaft 7 is shown extending to the trigger-hand grip 12 which is rigidly attached to the shaft 7 at the trigger-hand grip end. The trigger-hand grip 12 consists of a grip handle 16 which is fabricated contiguously with a tubular collar 17 to form a hand grip handle 18 which is rigidly attached to the shaft 7 by bonding, threading, or other fastening means. A trigger device 19, consisting of a trigger handle 20, having an extending thumb guard knob 21, is fabricated contiguously with a movable cable linkage housing 22. The trigger device 19 is attached to the hand grip handle 18 by means of a hinge pin 23. A cable tensioning thumb screw 24 engages a threaded eye 25 which is attached to the tensioning cable 27 by means described in FIG. 6. The trigger device 19 is held in the open position shown by tension in cable 27 and, thence, cables 10 and 11; this tension is caused by spring forces in the two spring arms 3 and 4 and by the position of the adjustable cable tensioning thumb screw 24 relative to the free end of the threaded eye 25. When the sponge end of the device is open, turning the cable tensioning thumb screw 24 clockwise results in added tension in cable 27 and, thence, cables 10 and 11 which, in turn, causes the spacing to be reduced between the ends of the spring arms 3 and 4 and between the attached sponges 1 and 2. Turning the cable tensioning thumb screw 24 counterclockwise reduces tension in cable 27 and, thence, in cables 10 and 11 which causes the spacing to be increased between the ends of the spring arms 3 and 4 and between the attached sponges 1 and 2 when the device is in the fully open position. The clamping pressure between sponges 1 and 2 and the consequent quantity of herbicide squeezed from them when the applicator device is in the fully closed position is controlled by adjusting the cable tensioning thumb screw 24.

Turning now to FIG. 5b, the hand-actuated trigger 12 is shown with the trigger device 19 compressed toward the grip handle 16. The trigger hand grip components are thermal/injection-formed from appropriate PVC or other plastic materials. The movable cable linkage housing 22, is shown rotated away from the tubular collar 17 which is attached to the shaft 7. The compressive gripping action of the hand on the trigger device 19 rotates the trigger handle 20 toward the grip handle 16 about hinge pin 23. This rotation causes the movable cable linkage housing 22, the cable tensioning thumb nut 24, the connected threaded eye 25, and a cable end clevis 26 to move away from the tubular collar 17. The movement of the cable end clevis 26 away from the tubular collar 17 results in additional tension in the tensioned cables 10 and 11. The added tension results in the closing of spring arms 3 and 4 and sponges 1 and 2 such that when the trigger device is fully compressed as shown in FIG. 5b the poly-foam sponges are fully compressed as shown in FIG. 4. When hand pressure on the trigger device 19 is released, the sponges 1 and 2 return to the fully open position as shown in FIG. 2.

As shown in FIG. 6, the two tension cables 10 and 11 are connected to a single cable 27 by means of a cable splice 28. The other end of the single cable 27 is connected to the cable end clevis 26 which is pinned-connected to the eye of threaded eye 25. The cable tensioning thumb nut 24, which is threaded to the threaded eye 25, bears flush against the exterior face of the cable linkage housing 22 so that tension is always maintained in the cables and connecting components.

FIG. 7 shows a tubular tee device 14 as one method of attachment of the optional stabilizing handle 13 of the device to the shaft 7. An optional tubular elbow 29, also shown, may be used to change the axis of the shaft 7 to provide a preferred angle of the shaft 7 at the sponges 1 and 2 end of the herbicide applicator with respect to the shaft 7 at the hand-actuated trigger 12 end of the device.

FIGS. 8a-d provide additional detailed views of one example embodiment of the snap-in connectors 5 and 6 shown in some previous Figures. FIG. 8a is a top view of a snap-in connector to be used in attaching, removing and/or replacing sponges on the spring arms of a hand-held herbicide applicator as described herein. FIG. 8b is a side view of the snap-in connector illustrated in FIG. 8a. A male component 30 and a female component 31 are shown. FIG. 8c is an end view of a female component 31 of the illustrated example embodiment snap-in connector, and FIG. 8d is an end view of a male component 30 of the same snap-in connector. In the illustrated example embodiment, the male component 30 of the snap-in connector is a flat, elongated extension of the flexible spring arms 3 and 4, encompassing a rectangular flat plate 32 and a flexible, raised elongated deformation 33 in that plate 32. In some embodiments, the flat plate has beveled corners 34. The male component 30 includes a slotted key hole 35, through which a cable-end stop sleeve 36 or similar cable-end attachment device is passed and engaged in tension in order to connect the tensioned cables 10 and 11 to the flexed spring arms 3 and 4 at or near the site of the snap-in connectors. The female component 31 of the snap-in connector generally encompasses a flexible, elongated, channel-shaped member 37 having a flat, rectangular plate 38 with side flanges 39 having extended fingers 40. A raised, flexible, and elongated deformation 41 in the flat rectangular plate 38 protrudes toward the opening between the fingers 40 of the channel-shaped member 37. In some embodiments, the flat, rectangular plate 38 includes an end flange stop 43 in order to limit the depth or degree of insertion of the male component 30 into the female component 31. The female component 31 generally is rigidly connected to the sponge 1, 2 by an adhesive or other attaching devices, such as embedded studs or other irregularities that engage the foam of the sponge during manufacture.

Inserting the male component 30 into the female component 31 of the snap-in connector 5 and 6, with the components oriented as shown in FIGS. 8a and 8b, causes the raised, flexible, and elongated defolination 33 of the male component 30 to engage the raised, flexible, and elongated deformation 41 in the female component 31. When engaged, these elongated deformations inhibit differential movement, twist, and rotation of the parts with respect to one another, thereby firmly holding the sponges 1 and 2 in correct orientation with respect to one another and to the spring arms 3 and 4.

In operation, several advantages of the example embodiments of the hand-held clamping herbicide applicator are achieved. For example, the illustrated example embodiments of the hand-held clamping herbicide applicator allow for the precise, targeted application of herbicide directly to a targeted plant, with minimal risk of unintentionally exposing neighboring plants to herbicide. The tubular shaft and the configuration of the device, with herbicide-carrying sponges at one end and the operator controls at the opposite end, enables the use of the device on ground-located plants by an operator who remains in a standing position. As described herein, a liquid applicator according to the present general inventive concept limits the application of the liquid to only the targeted object. Moreover, a liquid applicator according to the present general inventive concept uniformly applies the liquid to the targeted object and simultaneously applies liquid to more than a single side of the targeted object, since the sponges surround the targeted plant. Various embodiments, including the illustrated example embodiments, furthei nore permits the operator to control the volume of liquid or the application force applied to the targeted object. Various embodiments provide an apparatus and method for a liquid applicator that is easily cleaned, maintained, and repaired. Still further, it is an advantage of the preferred embodiments of the invention claimed herein to provide an apparatus and method for a liquid applicator that does not result in undesirable dripping of the liquid.

Thus, in various example embodiments of the present general inventive concept, a hand-held herbicide delivery device for targeted application of herbicide to a targeted plant encompasses a shaft having a length, a first end, and a second end; at least two spring arms located proximate said first end of said shaft, said spring arms being capable of moving between an open position and a closed position, at least two sponges affixed to said spring aims, such that when said spring arms are in a closed position said sponges are brought into close proximity with each other, said sponges being adapted to carry a herbicide; a hand-actuated trigger located proximate said second end of said shaft and being adapted to move between an extended position and a retracted position; flexible cables extending along a majority of the length of said shaft and adapted to move said spring arms between the open position and the closed position and adapted to move said sponges into close proximity with each other in response to movement of said hand-actuated trigger between the extended position and the retracted position; wherein herbicide is applied to the targeted plant by positioning the spring aims in the open position such that they surround the targeted plant and moving said hand-actuated trigger from the extended position to the retracted position so that the flexible cables move said spring arms into the closed position, with said sponges directly contacting at least a portion of the targeted plant, whereby herbicide is transferred from said sponges to the targeted plant.

In some embodiments, said herbicide includes liquid herbicide.

In some embodiments, the hand-actuated trigger is adapted to control the volume of herbicide applied to the targeted plant.

In some embodiments, the hand-actuated trigger is adapted to control the amount of force applied by the sponges to the targeted plant when said sponges are clamped around the targeted plant.

In some embodiments, the hand-held herbicide delivery device further includes a hand grip located proximate said hand-actuated trigger.

In some embodiments, the hand-held herbicide delivery device further includes, on each said spring arm, a member enabling attachment and detachment of a sponge to said spring an

In some example embodiments of the present general inventive concept, a liquid applicator adapted to apply a liquid to a targeted object includes a handle, said handle being adapted to be moved between an extended position and a retracted position; a first arm, said first arm having a first arm distal end and being adapted to be moved between a first arm open position and a first arm closed position; a first paddle, said first paddle being disposed on the first min distal end; a second arm, said second arm having a second arm distal end and being adapted to be moved between a second arm open position and a second arm closed position; a second paddle, said second paddle being disposed on the second arm distal end; means for moving said first arm from the first arm open position to the first arm closed position in response to movement of said handle from the extended position to the retracted position; and means for moving said second arm from the second arm open position to the second arm closed position in response to movement of said handle from the extended position to the retracted position; wherein the first paddle and the second paddle are adapted to releasably retain the liquid and apply the liquid to the targeted object; and wherein the first paddle and the second paddle are adapted to contact each other when the first arm is in the first aim closed position and the second arm is in the second arm closed position.

In some embodiments, the handle comprises a trigger.

In some embodiments, the handle is adapted to move the first arm to the first arm open position and the second arm to the second arm open position when the handle is in the extended position.

In some embodiments, the handle is adapted to move the first arm to the first arm closed position and the second aim to the second arm closed position when the handle is in the retracted position.

In some embodiments, the handle is adapted to control the volume of the liquid applied to the targeted object.

In some embodiments, the handle is adapted to control the amount of force applied by the first paddle and the second paddle to the targeted object.

In some embodiments, the first arm is operably connected to the handle by a shaft.

In some embodiments, the second arm is operably connected to the handle by a shaft.

In some embodiments, the first arm comprises a means for removably attaching the first paddle to the first arm.

In some embodiments, the second arm comprises a means for removably attaching the second paddle to the second arm.

In some embodiments, the first paddle comprises a sponge.

In some embodiments, the second paddle comprises a sponge.

In some embodiments, said means for moving said first arm from the first arm open position to the first arm closed position in response to movement of said handle from the extended position to the retracted position include at least one flexible cable.

In some embodiments, said means for moving said second arm from the second arm open position to the second arm closed position in response to movement of said handle from the extended position to the retracted position include at least one flexible cable.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations, and the same are intended to be comprehended within the meaning and range of equivalents of the appended claims.

What is claimed is:

1. A hand-held herbicide delivery device for targeted application of herbicide to a targeted plant, said device comprising:
(a) a shaft having a length, a first end, and a second end;
(b) at least two spring arms located proximate said first end of said shaft, said spring arms being capable of moving between an open position and a closed position,
(c) at least two sponges affixed to said spring arms, such that when said spring arms are in a closed position said sponges are brought into close proximity with each other, said sponges being adapted to carry a herbicide;
(d) a hand-actuated trigger located proximate said second end of said shaft and being adapted to move between an extended position and a retracted position;
(e) flexible cables extending along a majority of the length of said shaft and adapted to move said spring arms between the open position and the closed position and adapted to move said sponges into close proximity with each other in response to movement of said hand-actuated trigger between the extended position and the retracted position;
wherein herbicide is applied to the targeted plant by positioning the spring arms in the open position such that they surround the targeted plant and moving said hand-actuated trigger from the extended position to the retracted position so that the flexible cables move said spring arms into the closed position, with said sponges directly contacting at least a portion of the targeted plant, whereby herbicide is transferred from said sponges to the targeted plant.

2. The hand-held herbicide delivery device of claim 1 wherein said herbicide includes liquid herbicide.

3. The hand-held herbicide delivery device of claim 1 wherein the hand-actuated trigger is adapted to control the volume of herbicide applied to the targeted plant.

4. The hand-held herbicide delivery device of claim 1 wherein the hand-actuated trigger is adapted to control the amount of force applied by the sponges to the targeted plant when said sponges are clamped around the targeted plant.

5. The hand-held herbicide delivery device of claim 1 further comprising a hand grip located proximate said hand-actuated trigger.

6. The hand-held herbicide delivery device of claim 1 further comprising, on each said spring arm, a member enabling attachment and detachment of a sponge to said spring arm.

7. A liquid applicator adapted to apply a liquid to a targeted object, said liquid applicator comprising:
(a) a handle, said handle being adapted to be moved between an extended position and a retracted position;
(b) a first arm, said first arm having a first arm distal end and being adapted to be moved between a first arm open position and a first arm closed position;
(c) a first paddle, said first paddle being disposed on the first arm distal end;
(d) a second arm, said second arm having a second arm distal end and being adapted to be moved between a second arm open position and a second arm closed position;
(e) a second paddle, said second paddle being disposed on the second arm distal end;
(f) means for moving said first arm from the first arm open position to the first aim closed position in response to movement of said handle from the extended position to the retracted position; and
(g) means for moving said second arm from the second arm open position to the second arm closed position in response to movement of said handle from the extended position to the retracted position;
wherein the first paddle and the second paddle are adapted to releasably retain the liquid and apply the liquid to the targeted object; and wherein the first paddle and the second paddle are adapted to contact each other when the first aim is in the first arm closed position and the second arm is in the second arm closed position.

8. The liquid applicator of claim 7 wherein the handle comprises a trigger.

9. The liquid applicator of claim 7 wherein the handle is adapted to move the first arm to the first arm open position and the second arm to the second aim open position when the handle is in the extended position.

10. The liquid applicator of claim 7 wherein the handle is adapted to move the first arm to the first arm closed position and the second arm to the second arm closed position when the handle is in the retracted position.

11. The liquid applicator of claim 7 wherein the handle is adapted to control the volume of the liquid applied to the targeted object.

12. The liquid applicator of claim 7 wherein the handle is adapted to control the amount of force applied by the first paddle and the second paddle to the targeted object.

13. The liquid applicator of claim 7 wherein the first arm is operably connected to the handle by a shaft.

14. The liquid applicator of claim 7 wherein the second arm is operably connected to the handle by a shaft.

15. The liquid applicator of claim 7 wherein the first arm comprises a means for removably attaching the first paddle to the first arm.

16. The liquid applicator of claim 7 wherein the second aim comprises a means for removably attaching the second paddle to the second arm.

17. The liquid applicator of claim 7 wherein the first paddle comprises a sponge.

18. The liquid applicator of claim 7 wherein the second paddle comprises a sponge.

19. The liquid applicator of claim 7 wherein said means for moving said first arm from the first arm open position to the first arm closed position in response to movement of said handle from the extended position to the retracted position include at least one flexible cable.

20. The liquid applicator of claim 7 wherein said means for moving said second arm from the second arm open position to the second arm closed position in response to movement of said handle from the extended position to the retracted position include at least one flexible cable.
